(19) United States
(12) Patent Application Publication
(10) Pub. No.: US 2003/0064187 A1
(43) Pub. Date: Apr. 3, 2003

(54) Carbon fiber mast

(76) Inventor: Robert Blanchette, Pompano Beach, FL (US)

Correspondence Address: Mark D. Bowen, Stearns Weaver Miller, Suite 1900, 200 East Broward Boulevard, Fort Lauderdale, FL, 33301, US

(21) Appl. No.: 10/313,345

(22) Filed: Dec. 6, 2002

Related U.S. Application Data
(63) Continuation of application No. 09/531,070, filed on Mar. 18, 2000.

(51) Int. Cl. B32B 1/08

(52) U.S. Cl. 428/36.9

(57) ABSTRACT

A carbon fiber sailboat mast is provided having a number of elongated carbon fiber tubes bonded to each other and to an external carbon fiber tube which wraps them thereby forming a reinforced carbon fiber mast that is light in weight yet resistant to bending and twisting. A sail-attaching groove/track and a head sail boom track are added after structural components have taken shape.

### CROSS-REFERNCE TO RELATED APPLICATION

This Application is a Continuation of U.S. patent application Ser. No. 09/531,070 filed Mar. 18, 2000.

### STATEMENT REGARDING FEDERALLY FUNDED RESEARCH OR DEVELOPMENT N/A

### 1. BACKGROUND

a. Field of the Invention

The invention relates to free standing carbon fiber spars for sailboats and, more particularly to free standing carbon fiber spars capable of supporting a head sail from the top of the mast without significant bending or twisting such that head sail does not loose its-power.

b. Description of the Prior Art

Aluminum masts have been in use on sailboats for many years. In addition, carbon fiber spars including masts have been used for a number of years. FIGS. 1-6 depict prior art carbon fiber masts. These masts are intended to provide a carbon fiber spar with an integral sail-attaching groove at little or no additional cost as compared with aluminum spars. More particularly, FIGS. 1-4 depict a configuration for a carbon fiber mast as disclosed in U.S. Pat. No. 5,617,807, issued to Hulse et al. FIGS. 5 and 6 depict a carbon fiber mast made with two longitudinally extending pieces or halves that are glued together, after curing, to form the mast circumference. In other prior art carbon fiber mast designs, the mast is a tapered tube that does not include a sail-attaching groove. Instead, the sail is provided with a sleeve that fits over the tube, or a track is attached to the finished mast for sliding receiving cars attached along the edge of the sail.

Carbon fiber spars, and especially masts, provide improved performance on sailboats as compared with more typical aluminum masts due to the well known high strength and low weight properties of carbon fiber. Reducing weight in a sailboat mast is important because it reduces the pitching moment by a factor of the square of the distance to the center of mass of the boat.

Boats with high pitching moments perform poorly in a seaway. A prior art carbon fiber mast of given size and strength will weigh about one-half as much as an aluminum mast of similar size and strength, while further providing a sizable reduction in pitching moment and consequently improvement in performance.

What is desired, therefore, is a carbon fiber spat which utilizes the strength to weight properties of carbon fiber to carry more main sail area high on a free standing mast than physics will allow on a mast of the same height which is supported by standing rigging.

### SUMMARY OF THE INVENTION

It is an object of the invention to provide a free-standing carbon fiber spar which utilizes the performance advantage of carbon fiber.

Another object of the invention is to provide a free standing carbon fiber spat capable of supporting a head sail from the top without bending or twisting significant enough for the head sail to lose its power and/or efficiency.

Yet another object of the invention is to provide a free standing carbon fiber spar capable of carrying a main sail with a bigger per-cent of it's sail area at the top than is physically possible on a mast of the same height which is supported by standing rigging.

### BRIEF DESCRTPTION OF THE DRAWINGS

FIG. 1 is a front isometric view of a prior art carbon fiber spar in use on a sailboat;

FIG. 2 is an enlarged partial view of a prior art carbon fiber spar illustrating operation and use of the integral sail-attaching groove;

FIGS. 3 and 4 are cross-sectional views of another prior art carbon fiber mast;

FIG. 5 is an exploded end cross-sectional view of a prior art carbon fiber mast; and

FIG. 6 is an enlarged partial end cross-sectional view of the prior art carbon fiber mast of FIG. 5 depicting construction of the luff groove in additional detail.

FIG. 7 is a front isometric view of a sailboat having a carbon fiber mast according to the present invention;

FIG. 8 is a partial detailed cutaway view of a carbon fiber mast according to the present invention;

FIG. 9A is a cross-sectional view of the invention with the luff groove attached; and

FIG. 9B is a cross-sectional view of the invention with the luff groove structure unattached.

### DETAILED DESCRIPTION OF THE INVENTION

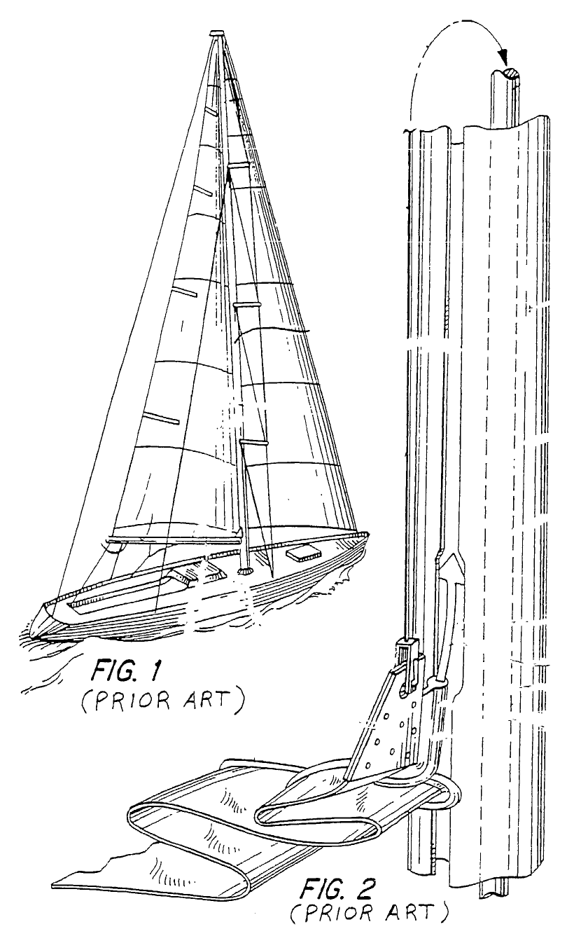

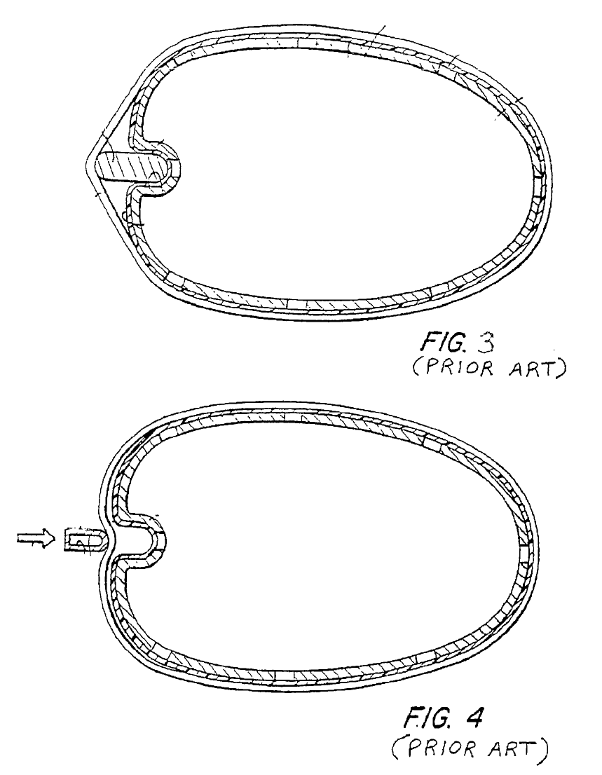

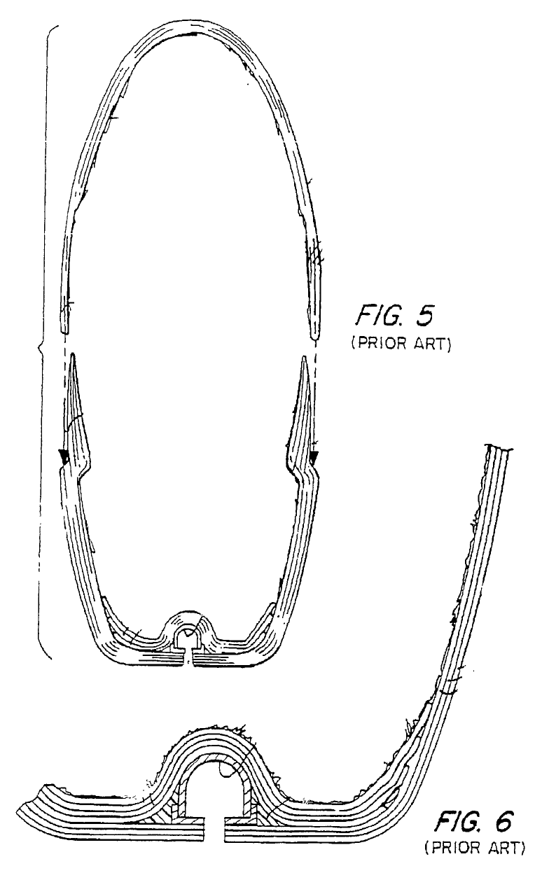

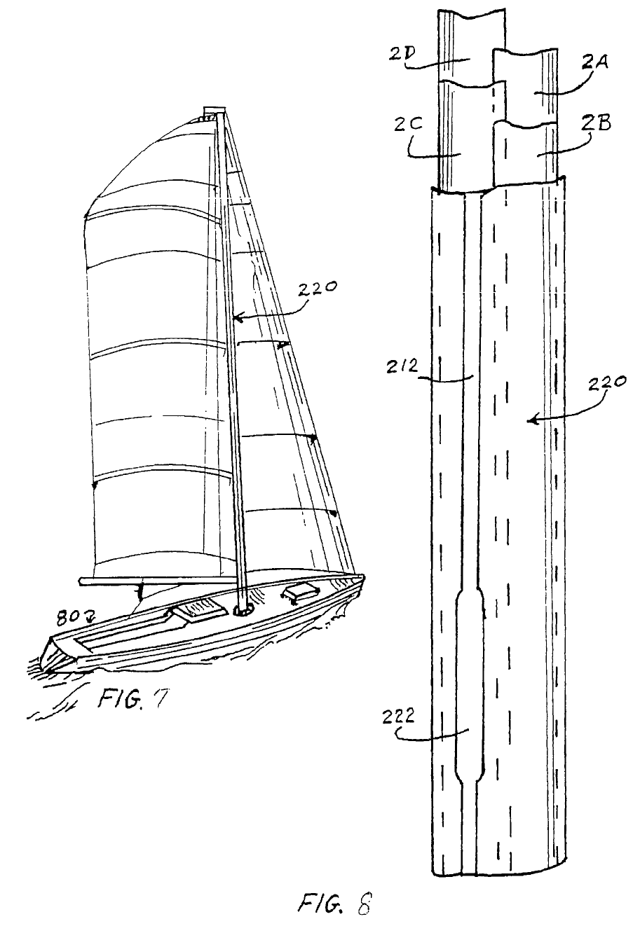

FIGS. 1 through 6 each illustrate various prior art carbon fiber sailboat masts. FIGS. 1 and 2 depict a sailboat having a prior art carbon fiber mast as disclosed in U.S. Pat. No. 5,617,807, issued to Hulse et al. FIGS. 3 and 4 are cross-sectional views of the carbon fiber mast disclosed by Hulse et al., and depict a substantially hollow interior and layered mast structure. FIGS. 5 and 6 depict yet another prior art carbon fiber mast formed of two attached half structures.

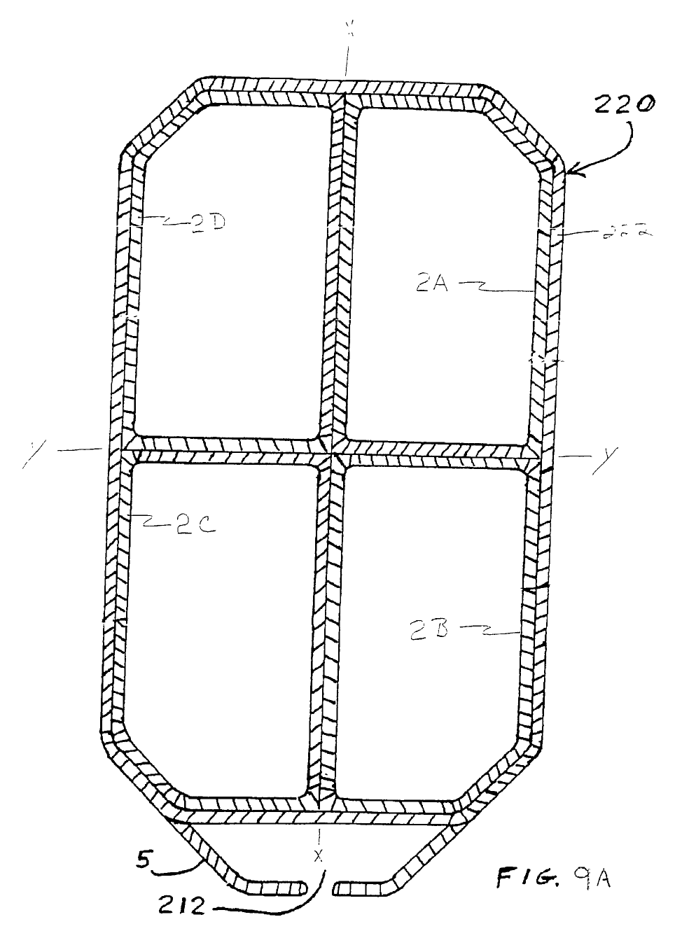

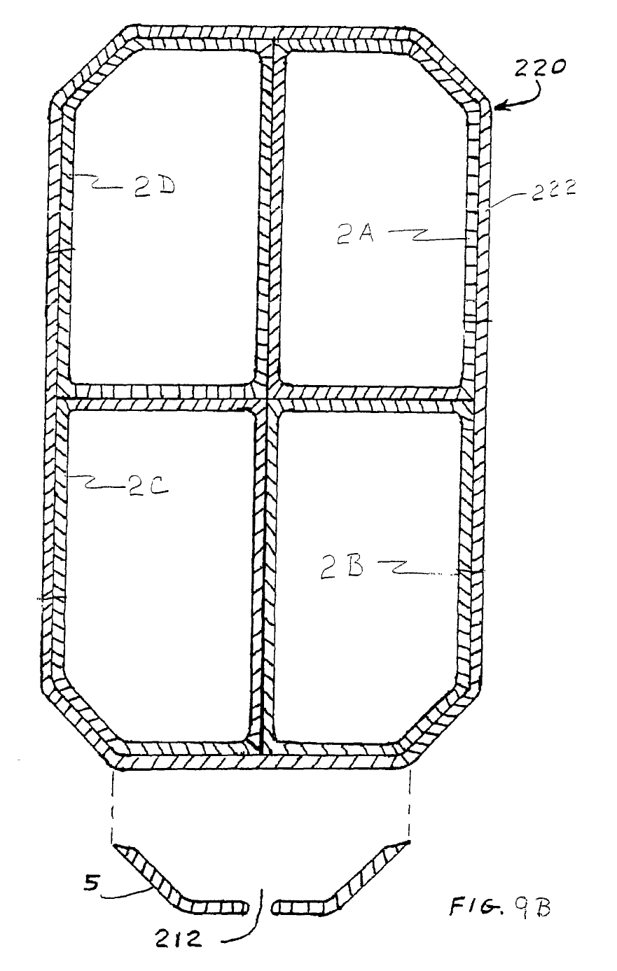

FIGS. 7 and 8 depict a carbon fiber mast, generally referenced as 220, according to the present invention in use on a sailboat 80. FIGS. 9A and 9B depict cross-sectional views of carbon fiber mast 220 according to the present invention. As best depicted in FIGS. 9A and 9B a carbon fiber or other high modulus fiber material is used to form an outer mast structure 222 in accordance with the invention, which spar is mounted and in use on a sailboat 80. A groove forming structure referenced as 5, defining a groove 212, for attaching a luff edge of a main sail to mast 220 may be bonded to outer mast structure 222 as shown in FIGS. 9A and 9B. Although, for simplicity, groove structure 5 is shown, it is understood that a track for attaching a luff edge of a mainsail can be attached instead.

As best depicted in FIGS. 9A and 9B mast 220 includes a plurality of internally disposed reinforced tubular members, referenced as 2A, 2B, 2C, and 2D respectively. Reinforced tubular members 2A-2D are each preferably elongate, generally rectangular members configured in adjacent, face-to-face relation to reinforce the outer mast structure 220. Reinforced tubular members 2A-2D are preferably bonded to one another and further bonded to the inner surface of the outer mast member 222 thereby forming reinforcing internal cross-members as represented by the X-X and Y-Y axes in FIG. 9A.

Although, for simplicity, only mast 220 is described in detail, it is also understood that other spars would operate and be manufactured in the same or a similar manner. Similarly, although the mast is preferably a resin matrix reinforced with carbon fiber, it is understood that Kevlar, spectra, fiberglass, and other fibers, particularly high modulus fibers may also be used.

Methods for fabricating the invention are well known in the art. Several known method can be used individually or in combination with each other to form the invention.

What I claim is:

1. A fiber reinforced sailboat mast comprising:
a plurality of internal tubular members;
an outer tubular member in surrounding relation with said plurality of tubular members;
said plurality of internal tubular members bonded together along XX and YY axes thereby forming an internal reinforcing structure for said outer tubular member.

2. A fiber reinforced sailboat mast according to claim 1, wherein said plurality of internal tubular members are further bonded to said outer tubular member.

3. A fiber reinforced sailboat mast according to claim 1, further including means for attaching a luff edge of a mainsail to said mast.

4. A fiber reinforced sailboat mast comprising:
four internal tubular members, each of said internal tubular members formed of multiple layers of resin impregnated fiber material;
an outer tubular member in surrounding relation with said plurality of tubular members;
said plurality of internal tubular members bonded together along XX and YY axes, and further bonded to an inner surface of said outer tubular member, thereby forming an internal reinforcing structure for said outer tubular member.

5. A fiber reinforced sailboat mast according to claim 4, further including means for attaching a luff edge of a mainsail to said mast.

6. A fiber reinforced sailboat mast according to claim 5, wherein said means for attaching a luff edge of a mainsail to said mast comprises a groove defining structure affixed to an outer surface of said outer tubular member.

7. A fiber reinforced sailboat mast according to claim 5, wherein said means for attaching a luff edge of a mainsail to said mast comprises a track affixed to an outer surface of said outer tubular member.

8. A fiber reinforced sailboat mast comprising:
an outer tubular elongate mast member having an interior surface defining an interior, said interior surface formed about a longitudinal axis;
said mast member internally reinforced from within said interior by internal members bonded to said interior surface of said mast member, said internal members forming a generally X shaped cross section extending substantially along the entire interior length of said mast member thereby reinforcing said mast member.

9. A fiber reinforced sailboat mast according to claim 8, further including means for attaching a luff edge of a mainsail to said mast.
